(19) United States
(12) Patent Application Publication
(10) Pub. No.: US 2016/0117764 A1
(43) Pub. Date: Apr. 28, 2016

(54) ENERGY EFFICIENCY REVERSE AUCTION SYSTEM AND METHOD

(71) Applicant: Overlay Consulting, Denver, CO (US)

(72) Inventor: Jonathan Dierking, Denver, CO (US)

(21) Appl. No.: 14/920,959

(22) Filed: Oct. 23, 2015

Related U.S. Application Data
(60) Provisional application No. 62/068,069, filed on Oct. 24, 2014.

(51) Int. Cl. G06Q 30/08

(52) U.S. Cl. CPC G06Q 30/08

(57) ABSTRACT

A computer-implemented energy efficiency reverse auction system and method where a monetary award is auctioned off to the bidder willing to generate the most energy efficiency for the monetary award. Bids are made in terms of cost per unit of energy efficiency. The system and method may provide access to bidder history graphics, an automatic low bid process, a buy now option, real-time auction pausing, bid-revoking functionality, auction end time automatic extensions, providing auction type images and program material, support for various energy efficiency incentive specific units, real-time chat functionality, bidder registration and database management, and any combination thereof.

### SUMMARY OF THE INVENTION

The present invention provides a computer-implemented energy efficiency reverse auction system and method. The method includes providing, to a plurality of qualified bidder clients, access to a reverse auction website. The reverse auction website provides a real-time auction interface.

The method also includes transmitting to the plurality of qualified bidder clients, over a network through the real-time auction interface, an indication of one or more energy efficiency monetary awards for one or more winners of an energy efficiency reverse auction. The method includes receiving from the qualified bidder clients, over a network through the real-time auction interface, a plurality of bids for one of the energy efficiency monetary awards. Each of the bids are associated with a bidder and indicate a price per unit of power saved, price per unit of renewable power generated, price per unit of tonnage reduced, or price per unit of HorsePower reduced for projects to be coordinated by one or more winners of the energy efficiency monetary award. The bid price is the rate that the winner of the auction will receive out of the energy efficiency monetary award for energy efficiency projects that it completes within a specified time frame.

The method also includes accessing from memory the bids for the one or more energy efficiency monetary awards and transmitting to qualified bidder clients, over a network through the real-time auction interface, the bids for the one or more energy efficiency monetary awards. The method further includes determining and providing through the real-time auction interface an amount of power saved or an amount of renewable power generated associated with one or more of the plurality of bids.

The method includes determining one or more winners of the reverse auction based on the one or more lowest bids for the one or more energy efficiency monetary awards and transmitting, over a network to the one or more winners of the reverse auction, an indication of winning one of the one or more energy efficiency monetary awards of the reverse auction.

The method may also include providing access to bidder history graphics, an automatic low bid process, a buy now option, real-time auction pausing, bid-revoking functionality, auction end time automatic extensions, providing auction type images and program material, support for various energy efficiency incentive specific units, real-time chat functionality, and bidder registration and database management.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z ; and Y, Z.

### BRIEF DESCRIPTION OF THE DRAWINGS

FIG. 1 illustrates a network diagram of one embodiment of the present invention.

FIG. 2 illustrates a flowchart of one embodiment of the present invention.

FIG. 3 illustrates one embodiment of a reverse auction interface of the present invention.

### DESCRIPTION OF THE CURRENT EMBODIMENT

The present invention is generally directed to a computer-implemented energy efficiency reverse auction system and method where a monetary award is auctioned off to the bidder willing to generate the most energy efficiency for the monetary award. Bids are made in terms of cost per unit of energy efficiency. For example, a bid of $0.025 per Kilowatt Hour (kWh) for a $100,000 energy efficiency monetary award means that the bidder agrees to implement energy efficiency projects over a predetermined period of time that will save at least 4,000,000 kWh

. A bid of $0.020 per kWh for the same $100,000 energy efficiency award would beat the $0.025 per kWh bid because the $0.020 bid means that the bidder agrees to implement energy efficiency projects over the same predetermined period of time that will save at least 5,000,000 kWh.

The reverse auction can be setup with an established bid ceiling price, auction length, award amount, cost per unit bid type, auction ID, and other various settings. The bidders bid down from the bid ceiling price until the auction length expires at which time the bidder with the lowest cost per unit bid price are deemed winners and become an incentive awardee. In one embodiment, the award amount is reserved for the winner and the winner draws from the award amount based on the cost per unit bid price that won the auction upon completion of energy efficiency projects. In some embodiments, the reverse auction can be configured to have multiple winners. In this case, each of the winning bids become an incentive awardee and can draw from the award amount based on their winning cost per unit bid price.

The type of unit in the cost per unit bid can vary. In some embodiments, the auction is bid in terms of price per kWh, kW, Therms, Horsepower (HP), Ton of cooling, or another energy efficiency unit. In some embodiments the cost per unit bid is in terms of the cost per unit of power saved. In other embodiments the cost per unit bid is in terms of the cost per unit of renewable power generated. That is, in some circumstances the bidders are placing bids in the reverse auction in terms of the price per unit of power that is saved when replacing an energy consumption device with a more energy efficient energy consumption device. For example, upgrading incandescent or other energy inefficient lighting units to LED or other more efficient lighting units. In other circumstances the bidders are placing bids in the reverse auction in terms of the price per unit of power that is generated for completing a renewable energy generation project, for example installation of a wind farm. In both scenarios these bids are referred to as energy efficiency reverse auctions. Some examples of various unit types for different embodiments of reverse auctions include customer only upgrades ($/kWh); LED projects ($/Watt reduced); VFDs—compressed air only ($/HP); VFD—all applications ($/Watt reduced); other project types ($/kWh).

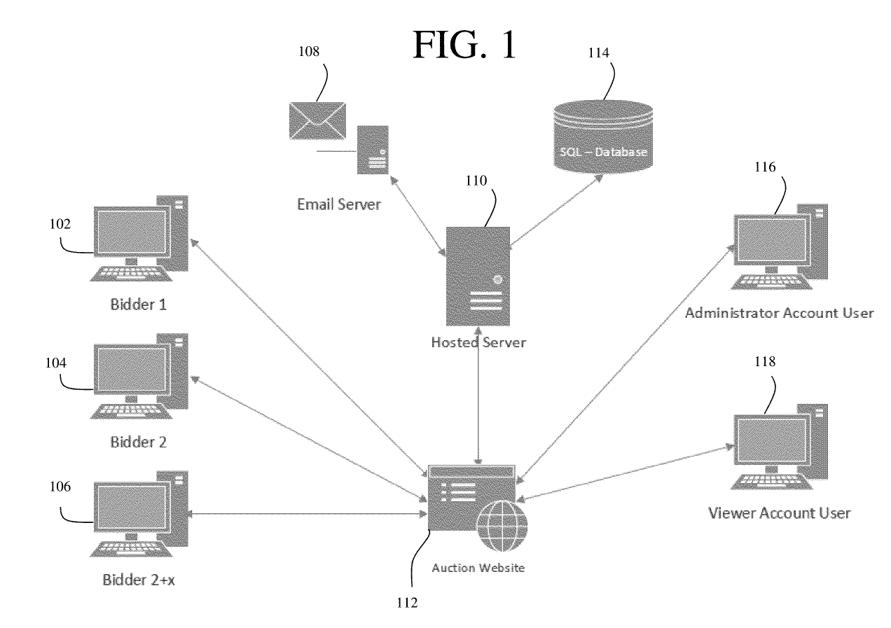

The computer-implemented energy efficiency reverse auction system and method can be implemented in a number of different embodiments utilizing a variety of different hardware and software components. Referring to FIG. 1, a network diagram of one embodiment of a computer-implemented energy efficiency reverse auction system is illustrated. The computer-implemented energy efficiency reverse auction system and method can be implemented on a reverse auction website 112 hosted on a server 110. Various clients 102, 116, 118 can access the auction website 112 on the hosted server 110. The auction website can access an internal or external database 114 and internal or external email server 108.

The auction website 112 implements a real-time auction interface for achieving cost effective energy savings and/or energy generation. The interface can be used to allocate energy efficiency and renewable energy incentives on behalf of electric and natural gas utility rebate programs.

The reverse auction interface allows qualified energy efficiency and renewable energy providers to competitively bid for incentives through an online reverse auction. An energy efficiency provider refers to an entity that coordinates and implements energy efficiency projects such as improved lighting energy efficiency projects or improved variable frequency drive energy efficiency projects. A renewable energy provider refers to an entity that coordinates and implements renewable energy projects such as wind farm construction.

Incentive dollars are allocated to qualified providers based on a lowest-price obtained through the reverse auction. The auction is executed through an online interface allowing providers to make real-time bids on $/kWh, $/kW, $/Therm, $/Ton, or $/HorsePower ($/HP) saved or generated for expected energy efficiency and renewable energy projects. The online auction can utilize predetermined starting bid amounts and bid decrements to ensure that incentive dollars are provided in a cost effective manner utilizing business drivers and market forces to achieve an appropriate rate. The winning bidders are tasked with identifying customers to implement energy efficiency and renewable energy projects that will expend their awarded funds.

FIG. 1 illustrates a network diagram for one embodiment of an energy efficiency reverse auction system. The system includes a server 110 hosting an auction website 112, a plurality of bidder clients 102, an administrator client 116, a viewer account client 118, a database 114, and an email server 108. Although the illustrated embodiment of the computer-implemented energy efficiency reverse auction system is implemented on a reverse auction website 112 using the Hypertext Markup Language, alternative embodiments may be implemented utilizing a different protocol.

In the current embodiment, the server 110 includes software capable of accepting requests from various clients and giving responses accordingly. In the current embodiment, the server 110 includes software for the reverse auction website, which provides a real-time auction interface. The real-time auction interface allows an administrator client to setup and configure energy efficiency reverse auctions. The real-time auction interface also allows bidder clients to submit bids and receive bids from other bidder clients along with other information related to the reverse auction.

Setting up an energy efficiency reverse auction may include configuring an award amount for the energy efficiency auction. The award amount represents the monetary incentive amount that will be provided to the winners of the auction and can be drawn from based on the amount of power saved or generated by energy efficiency projects coordinated or implemented by the auction winner. A category for the auction can be configured such that the monetary incentive amount can be tailored to the type of energy efficiency project to be implemented for receiving the monetary incentive. For example, one reverse auction may provide a monetary incentive amount for energy efficient lighting projects. Another reverse auction may provide a monetary incentive amount for renewable energy generation projects. The starting bid price, start time of the auction, length of the auction, and minimum bid decrement can also be configured during the setup of the reverse auction. The various details regarding any energy efficiency reverse auctions can be stored in a database 114. The database 114 can be a local database on the server 110, or a third party remote database that is accessed by the server 110.

Once an energy efficiency reverse auction has been setup, the server can receive bids from the bidder clients 102 and provide information to the various clients 102, 116, 118 about the auction in real-time. For example, a user can enter a bid into the bidder client 102, which is sent to the server 110 where the real-time auction interface processes the bid and accesses a database 114 to store the bid information. This bid information can be accessed and provided back to the various clients 102, 116, 118 in real time. The total amount of power saved or generated can be calculated in real-time based on the bid price and award amount. This amount of power saved or generated can be displayed in the real-time auction interface for the various clients 102, 116, 118.

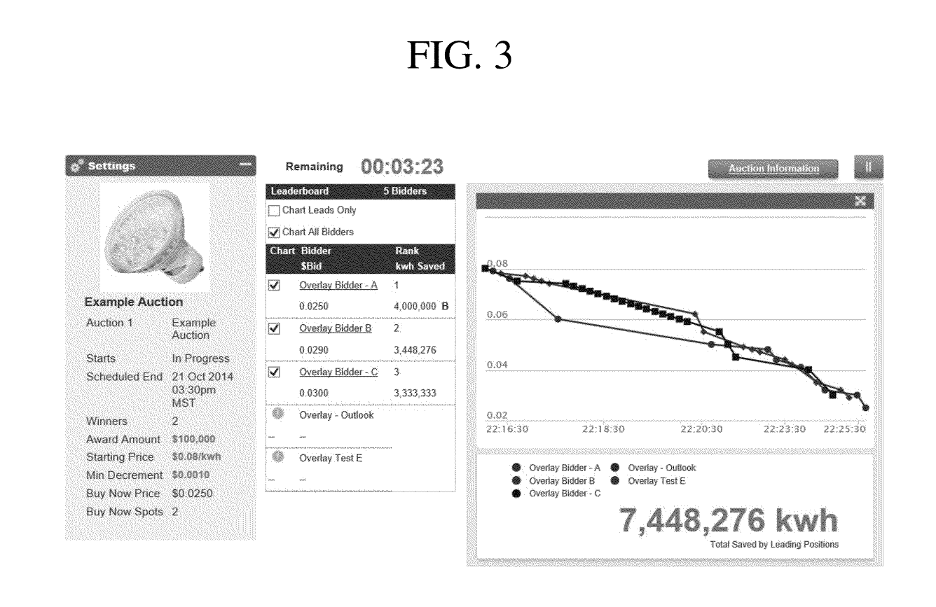

The real-time auction interface can provide various metrics about the real time auction during and after its conclusion. For example, a graphical timeline showing the bid timing can be illustrated using the real-time reverse auction interface. Further, the graphical timeline can be interactive and selectively illustrate the bidding history for various bidders in the reverse auction. The real-time reverse auction interface can also indicate the various bidder client rankings along with their name, current bid price, and amount of power saved or generated, as illustrated in FIG. 3.

Although information can be provided to the various clients in real-time as the auction is occurring, information can also be provided outside of the real-time auction interface. The server can send out emails or other communication to users. For example, in one embodiment, users may be sent an email notification when they are outbid, when the auction closes, when the auction is nearing completion, or based on another event associated with the reverse auction. The email may be sent using an email server 108, which can be remote or integrated into the server 110.

In the current embodiment, the various clients 102, 116, 118 can communicate through a network (such as the Internet) with the hosted server 110. The clients 102, 116, 118 are smartphones, desktop computers, laptops, or other electronic devices capable of accessing the reverse auction interface of the auction website 112. The bidding clients 102 can be used to submit bids for the reverse auction. The administration client 116 can be used for administration of the reverse auctions. This may include setting up, configuring, pausing, cancelling, or otherwise editing any of the reverse auction settings. The viewer client 118 may provide access to view the auctions in real time, but without providing the ability to bid.

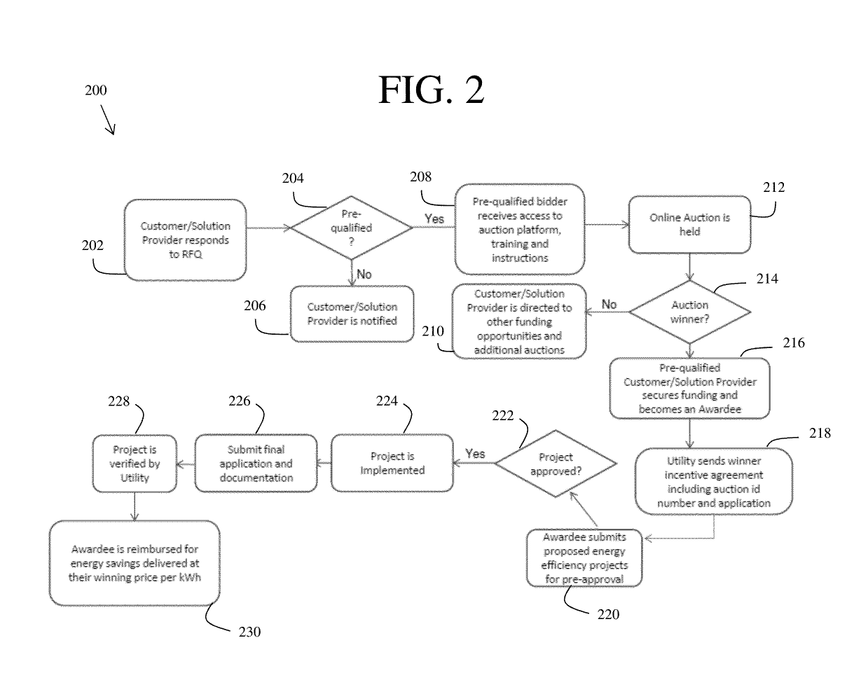

FIG. 2 illustrates one embodiment of a computer-implemented energy efficiency reverse auction method. The method includes receiving responses to request for qualification by customer/solution energy efficiency providers 202. A decision about whether to qualify an energy efficiency provider can be made based on a number of factors 204. The factors can include the number and type of energy efficiency projects previously completed. The customer/solution provider is notified if they are not qualified 206. If the customer/solution energy efficiency provider is qualified then they are sent information and instructions for accessing the reverse auction interface 208. For example, each qualified customer/solution energy efficiency provider can be provided with a separate bidder client login so that they can participate in reverse auctions held by the reverse auction system.

The method includes holding an online energy efficiency reverse auction 212. A determination is made as to the winner of the reverse auction 214. If the customer/solution provider did not win, they can be notified and directed to other funding opportunities and additional auctions 210. If they did win, they are notified and become an awardee 216. The sponsor of the auction, typically a utility company, provides the winner with an incentive agreement including an auction identification number and an application 218. The awardee submits proposed energy efficiency projects for pre-approval 220. Once the projects are approved 222 by the auction sponsor, the project can be coordinated and implemented 224. Upon project completion, the final application and documentation may be submit by the awardee 226. Once the project is verified by the utility 228, the awardee is reimbursed for energy savings delivered at their winning price 230.

The computer-implemented energy efficiency reverse auction system and method may incorporate numerous functionalities, which have been specifically designed for the energy efficiency and renewable energy incentive program sector. For example, functionality may be provided for providing access to bidder history graphics, an automatic low bid process, a buy now option, real-time auction pausing, bid-revoking functionality, auction end time automatic extensions, providing auction type images and program material, support for various energy efficiency incentive specific units, real-time chat functionality, and bidder registration and database management.

In one embodiment, the energy efficiency reverse auction interface may include three distinct login types for bidders, viewers and administrators. Each login type may have its own customized view. When logged in as a bidder, the user may have the ability to place bids as well as view “graphically” their bid history in a line graph chart and table format. When logged in as a Viewer or Administrator the user is able to see the bid history for all bidders within each individual auction. This information is also shown in a line graph chart and table format.

The auction interface can allow bidders to place an “auto low” bid, which will automatically keep them in first place down to their low bid set amount. This auto low bid function can automatically put their bid amount one bid decrement below the next lowest bid. Once another user bids below their auto low bid set amount, the user can be sent an auto generated email indicating that their auto low bid has been out bid.

The auction interface can provide the incentive provider the ability to set a low bid amount that the provider is willing to accept for a given auction. This can be setup as a “Buy Now” option within the auction configuration. Based on the auction design, the incentive provider can select the Buy Now unit price and the number of awards available. Bidders participating in auctions with a Buy Now available can select this option to lock in the award without waiting for the auction to close. Within the live auction interface, bidders can be provided information on the number of Buy Nows available and are given updates when the Buy Nows are selected by other bidders. This includes the total number available and the amount remaining.

When logged in as an Administrator, the reverse auction interface may provide the ability to pause and restart live auctions. When a live auction is paused the administrator can also revoke individual bids. This functionality provides the ability to change incorrect bids placed by bidders within a live auction scenario.

When creating a new auction, administrative users may have the ability to set an auto-extension option for a given auction. The auto-extension allows the auction to extend for a set time frame if a bid is placed in the last one minute of the auction. This functionality mitigates the issue of bidders trying to “snipe” the auction by placing a low bid at the last second. The auction auto-extension can be configured to extend for a predetermined range of time, for example from one to five minutes for each extension and can include a maximum auto-extension limit, for example from five minutes to one hour of additional time.

Due to the multitude of auction incentive types the auction interface may include a graphical user interface that has customizable images for each auction. This allows bidders to quickly identify the auction type they wish to bid in. The auction site also allows the administrator to upload program materials which may be downloaded by bidders. This information is editable when setting up an individual auction and can be provided in text format as well as a downloadable PDF, or other appropriate format.

Due to the uniqueness of the energy efficiency and renewable energy incentive space, specific units have been included within the auction platform that are not provided in traditional auction platforms. For example, these available units include $/kWh, $/kW, $/Ton, $/HP and $/Therms. Depending on the type of unit selected for each auction the site automatically updates the total amount of energy saved information provided to the bidders during the live auction.

The auction website may include a live chat functionality that allows bidders to communicate with the administrator during a live auction. This can be facilitated through an instant messenger chat window. When the administrator is not logged into the auction site, bidders have the ability to submit an email to the administrator through the chat window. All communication through the chat functionality can be saved for record retention purposes.

The auction platform may include a fully integrated bidder, viewer and administrator account registration process. This registration includes user setup by an administrator account, direct email to the new user with login and temporary password information and the ability for users to change contact and password information upon login. All of this information can be stored in a secure SQL server database that is fully editable through an Administrator user account.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A computer-implemented energy efficiency reverse auction method comprising:
providing, to a plurality of qualified bidder clients, access to a reverse auction website, wherein the reverse auction website provides a real-time auction interface;
transmitting to the plurality of qualified bidder clients, over a network through the real-time auction interface, an indication of one or more energy efficiency monetary awards for one or more winners of an energy efficiency reverse auction;
receiving from the plurality of qualified bidder clients, over a network through the real-time auction interface, a plurality of bids for one of the one or more energy efficiency monetary awards, wherein each of the plurality of bids are associated with a bidder and indicate currency per unit of power saved or currency per unit of power generated for projects to be coordinated by one or more winners of the energy efficiency monetary award;
accessing from memory the plurality of bids for the one or more energy efficiency monetary awards;
transmitting to the plurality of qualified bidder clients, over a network through the real-time auction interface, the plurality of bids for the one or more energy efficiency monetary awards;
determining and providing through the real-time auction interface an amount of power saved or an amount of power generated associated with one or more of the plurality of bids;
determining one or more winners of the reverse auction based on the one or more lowest bids for the one or more energy efficiency monetary awards;
transmitting, over a network to the one or more winners of the reverse auction, an indication of winning one of the one or more energy efficiency monetary awards of the reverse auction.

2. The method of claim 1 wherein the method includes:
receiving from one of the plurality of qualified bidder clients, over a network through the real-time auction interface, an automatic low bid threshold;
determining one or more leaders of the reverse auction based on which of the plurality of bids for the one or more energy efficiency monetary awards are the one or more lowest bids;
repeatedly comparing the one or more lowest bids for the one or more energy efficiency monetary awards to the automatic bid threshold;
in response to the automatic bid threshold being lower than at least one of the one or more lowest bids, automatically generating a bid lower than the at least one of the one or more lowest bids.

3. The method of claim 1 wherein the reverse auction has a buy it now bid price.

4. The method of claim 1 includes pausing the reverse auction by
notifying the plurality of qualified bidder clients, over a network through the real-time auction interface, that the reverse auction is paused during a paused time period; and
refusing to accept new bids from the plurality of bidder clients during the paused time period;

5. The method of claim 4 including accessing from memory the plurality of bids for the one or more energy efficiency monetary awards during the paused period; and modifying or revoking the plurality of bids during the paused period.

6. The method of claim 1 wherein the reverse auction has an end time and the method includes automatically extending the end time in response to receiving a bid within a predetermined period before the end time.

7. The method of claim 1 wherein currency per unit of power saved or currency per unit of power generated includes at least one of $/kWh, $/kW, $/Therm, $/Ton and $/HP.

8. The method of claim 1 including:
receiving, over a network from a plurality of prospective bidders, a plurality of requests for bidder qualification;
processing the plurality of requests for bidder qualification;
accessing a database and identifying one or more of the plurality of prospective bidders as qualified bidders;
transmitting, over a network, a qualification notice to each of the qualified bidders.

9. The method of claim 1 wherein the plurality of real-time bids are anonymized.
